(19) United States
(12) Patent Application Publication
(10) Pub. No.: US 2006/0253547 A1
(43) Pub. Date: Nov. 9, 2006

(54) Universal music apparatus for unifying access to multiple specialized music servers

(76) Inventors: Anthony John Wood, Palo Alto, CA (US); Michael Joseph Kobb, Belmont, CA (US); Gregory Mack Garner, Springdale, AR (US); Daniel Sletten, Redwood City, CA (US); Donald Robert Woodward JR., Monte Sereno, CA (US)

Correspondence Address: COOLEY GODWARD, LLP, 3000 EL CAMINO REAL, 5 PALO ALTO SQUARE, PALO ALTO, CA, 94306, US

(21) Appl. No.: 11/327,180

(22) Filed: Jan. 6, 2006

Related U.S. Application Data
(60) Provisional application No. 60/642,287, filed on Jan. 7, 2005.
(60) Provisional application No. 60/695,578, filed on Jun. 29, 2005.

(51) Int. Cl. G06F 15/16

(52) U.S. Cl. 709/217

(57) ABSTRACT

A computer readable medium, system, method and universal music apparatus are disclosed for unifying access over a network to multiple specialized music servers. According to one embodiment of the present invention, a universal music apparatus can include a universal discovery module to discover specialized music servers responsive to one or more discovery protocols, an object manager to determine music server processes for serving music files in accordance with one or more communication protocols, and a number of interfaces each being configured to exchange data with an associated music server process using one or more communication protocols that the universal music apparatus can implement. The generalized music server functions enable the universal music apparatus to communicate with any of the discovered music servers, which typically require music players to perform only the proprietary, unique functions of a specialized music server. In one embodiment, a universal music player provides for fast browsing of music libraries, among other things.

### CROSS REFERENCE TO RELATED APPLICATION

This application claims the benefit of U.S. Provisional Application No. 60/642,287, entitled “Universal Music Apparatus for Unifying Access to Multiple Specialized Music Servers” and filed on Jan. 7, 2005 with Attorney Docket No. ROKU-003/00US, the disclosure of which is incorporated herein by reference in its entirety. In addition, this application also claims the benefit of U.S. Provisional Application No. 60/695,578, entitled “Method, Apparatus, System and Computer Readable Medium for Providing a Universal Media Data Interface to Control a Universal Media Apparatus” and filed on Jun. 29, 2005 with Attorney Docket No. ROKU-005/00US, the disclosure of which is incorporated herein by reference in its entirety.

### BRIEF DESCRIPTION OF THE INVENTION

This invention relates generally to accessing digitized music files on multiple specialized music servers sharing a computer network. More particularly, this invention relates to a technique for representing proprietary, unique functions of specialized music servers as generalized functions in a music server model so that those unique functions can be mapped to those generalized functions. Also, the invention relates to a music player having user inputs and outputs configured to provide fast browsing of music libraries, among other things.

### BACKGROUND OF THE INVENTION

Music server processes are implemented on various computing device hardware platforms (i.e., music servers), to serve music in a digitized music format to networked clients. Generally, conventional music server processes include discovery protocols and communication protocols that both are proprietary and specialized. As used herein, a discovery protocol can refer to any procedure that can be used to identify, or “discover,” music servers on a network that operate with the same discovery protocol. A communication protocol is a procedure for regulating data transmissions over a network between music clients and music servers. Notably, a communication protocol can include, in whole or in part, a data access protocol, which is a procedure used to browse and/or to query music servers over a network and to retrieve data typically stored in a relational music database. Because music server processes implement unique functions, so too must music clients, which are commonly referred to as “network music players,” or just music players. Examples of common specialized music server processes are depicted in FIG. 1.

FIG. 1 shows a system 100 of networked music players and music servers. Music player (“1”) 110 is coupled via network 102 to a computing device constituting a music server 112, which implements specialized server process (“A”) 114. Similarly, music player (“2”) 120 and music player (“3”) 130 couple via network 102 to music server (“2”) 122 and music server (“M”) 132, respectively. Note that music server 122 implements server process (“B”) 124 and music server 132 implements server process (“N”) 134, both server processes being unique and thus generally incompatible with each other and their corresponding music players.

Note that each server process illustrated in FIG. 1 can represent either a unique discovery protocol or a unique communication protocol, or both. For instance, consider that server process (“A”) 114 uses the Simple Service Discovery Protocol (“SSDP”), which is maintained by the Internet Engineering Task Force (“IETF”) as its discovery protocol. Further, server process (“A”) 114 uses Universal Plug and Play (“UPnP”) techniques to enable music player (“1”) 110 to communicate and/or access music and music-related data on music server (“1”) 112, UPnP being certified by the UPnP™ Forum. This kind of music server can be referred to as an “UPnP server,” an example of which is the Windows Media Connect music server as manufactured by Microsoft Corporation of Redmond, Wash. As another example, consider that server process (“B”) 124 uses Rendezvous as its automatic discovery protocol. Rendezvous is an open protocol that Apple Computer, Inc. of Cupertino, Calif. has submitted to the IETF for regulation. To access music on music server (“2”) 122, music player (“2”) 120 operates in accordance with the Digital Audio Access Protocol (“DAAP”), which is a communication protocol different than that used by a UPnP server. This kind of music server can be referred to as a “DAAP server,” an example of which is the iTunes music server as manufactured by Apple Computer, Inc. Server process 134 can represent any other different type of music server process.

While the foregoing music players are functional, there is a common drawback in the implementation of a single music player when two or more different music server processes share the same network. As traditional music players are compatible with a limited number of discovery protocols and communication protocols (usually limited to one of each), music data stored on another server having different protocols would be inaccessible to most music players that do not operate with the same protocols. Listeners of music, therefore, have limited choices when selecting a music player, as the underlying server processes fundamentally predetermine their choices. Should a listener seek to modify a music player to interact with different server processes, then specialized knowledge is required to do so. Such modifications require knowledge of those specialized protocols.

In view of the foregoing, it would be highly desirable to provide a universal music player configurable to implement a variety of discovery and communication protocols. In particular, it would be highly desirable to represent proprietary, unique functions of specialized music servers as generalized (or server-independent) functions in a server model that maps those generalized functions to corresponding unique functions. Further, it would be highly desirable to provide a universal music player that is configured to provide fast browsing of music libraries, among other things.

### SUMMARY OF THE INVENTION

A computer readable medium, system, method and universal music apparatus are disclosed for unifying access over a network to multiple specialized music servers. According to one embodiment of the present invention, a universal music apparatus can include a universal discovery module to discover one or more specialized music servers on a network. In a specific embodiment, the universal music apparatus includes a program engine configured to communicate via one or more communication protocols with any of said multiple specialized music servers, and access any of said multiple specialized music servers to retrieve media data, which can include music data from music files and/or visual data representing a digitized image. In at least one embodiment, at least two of the one or more specialized music servers are responsive to different discovery protocols. In an alternative embodiment, the one or more specialized music servers can be responsive to the same discovery protocol and/or communications protocol. Generally, those at least two specialized music servers are only responsive to unique discovery protocols that are incompatible each with each other. Once discovered, each specialized music servers is identified as a discovered music server. In a specific embodiment, the universal music apparatus can also include an object manager to determine music server processes implemented in each of the discovered music servers, the music server processes each operating to serve music files in accordance with different communication protocols. The object manager selectably associates generalized music server functions to the interfaces thereby enabling the generalized music server functions to communicate with any of the discovered music servers. Further, the universal music apparatus also includes a number of interfaces each being configured to exchange data with an associated music server process using a specific communication protocol of the different communication protocols. The associated music server process is one of any number of music server processes accessible via a network by the universal music apparatus.

### BRIEF DESCRIPTION OF THE FIGURES

The invention is more fully appreciated in connection with the following detailed description taken in conjunction with the accompanying drawings, in which:

FIG. 1 shows a system of conventional networked music players and music servers;

FIG. 2 is a system including a universal music player, according to at least one embodiment of the present invention;

FIG. 3 is a flow diagram exemplifying a method in which a universal music player forms a music server object, according to an embodiment of the present invention;

FIG. 4 shows an example of a music server model from which a music server object is formed, according to an embodiment of the invention;

FIG. 5A introduces an architecture in which music server objects (“MSOs”) are implemented in a computing device for unifying access to a number of specialized music servers, according to at least one embodiment of the present invention;

FIG. 5B depicts examples of generalized menus presented by a user interface, according to an embodiment of the invention;

FIGS. 6A to 6D illustrates a functional block diagram depicting the functionality of the fast browse module of FIG. 5A, according to a specific embodiment of the present invention;

FIG. 7 illustrates a functional block diagram depicting the functionality of the font adjuster module of FIG. 5A, according to a specific embodiment of the present invention;

FIG. 8 illustrates a functional block diagram depicting the functionality of the Internet radio pseudo-server of FIG. 5A, according to a specific embodiment of the present invention;

FIG. 9 illustrates a functional block diagram depicting the functionality of the program update module of FIG. 5A, according to a specific embodiment of the present invention;

10-13B illustrate an exemplary housing for a universal music player, in accordance with various embodiments of the present invention;

FIG. 14 shows an ornamental design for a universal music player, whereby the broken lines illustrating graphical information on a display are for illustrative purposes only and form no part of the design; and

FIG. 15 shows a user interface for modifying the language in which information is displayed, according to an embodiment of the invention.

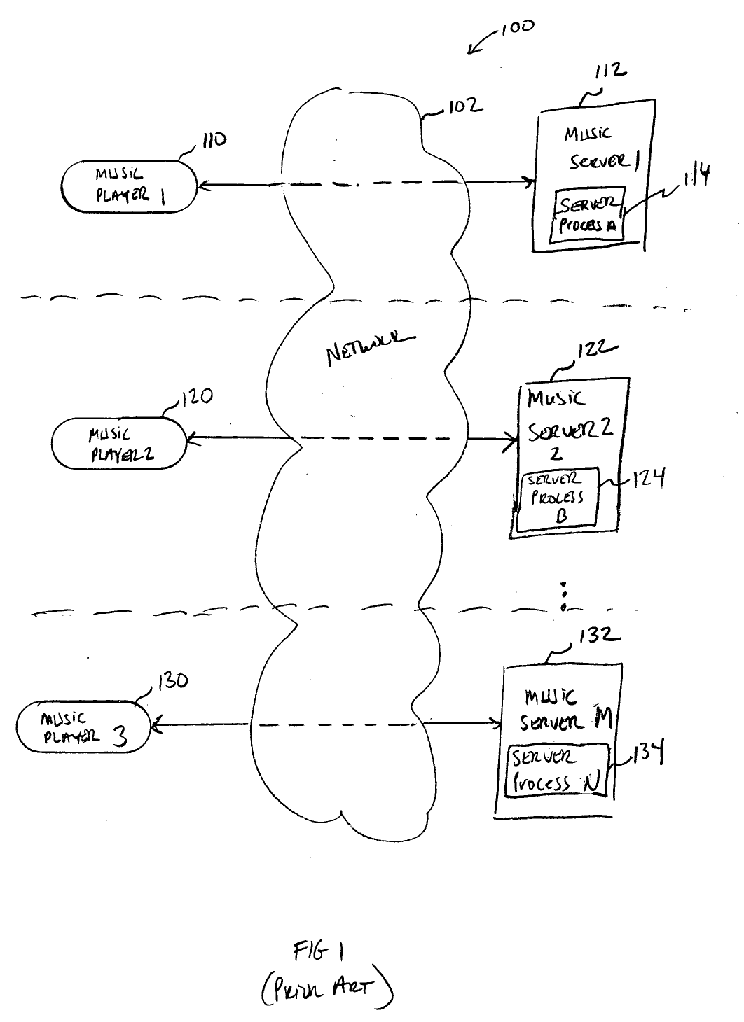

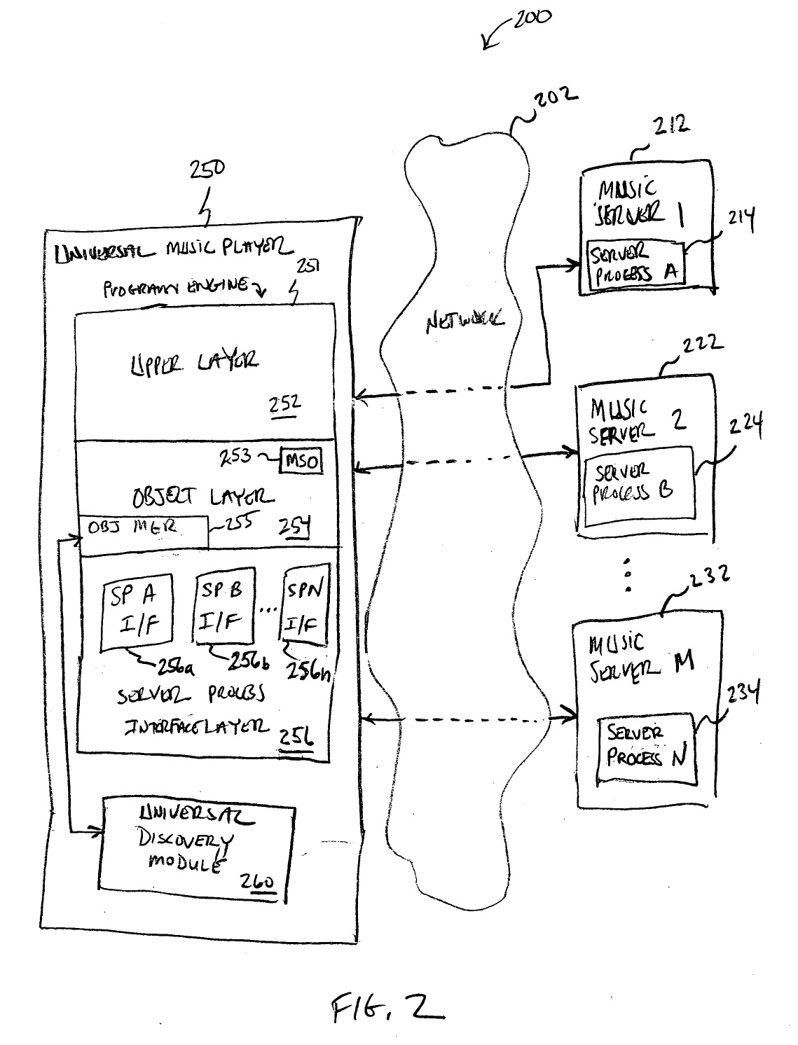

Like reference numerals refer to corresponding parts throughout the several views of the drawings.

### DETAILED DESCRIPTION OF EXEMPLARY EMBODIMENTS

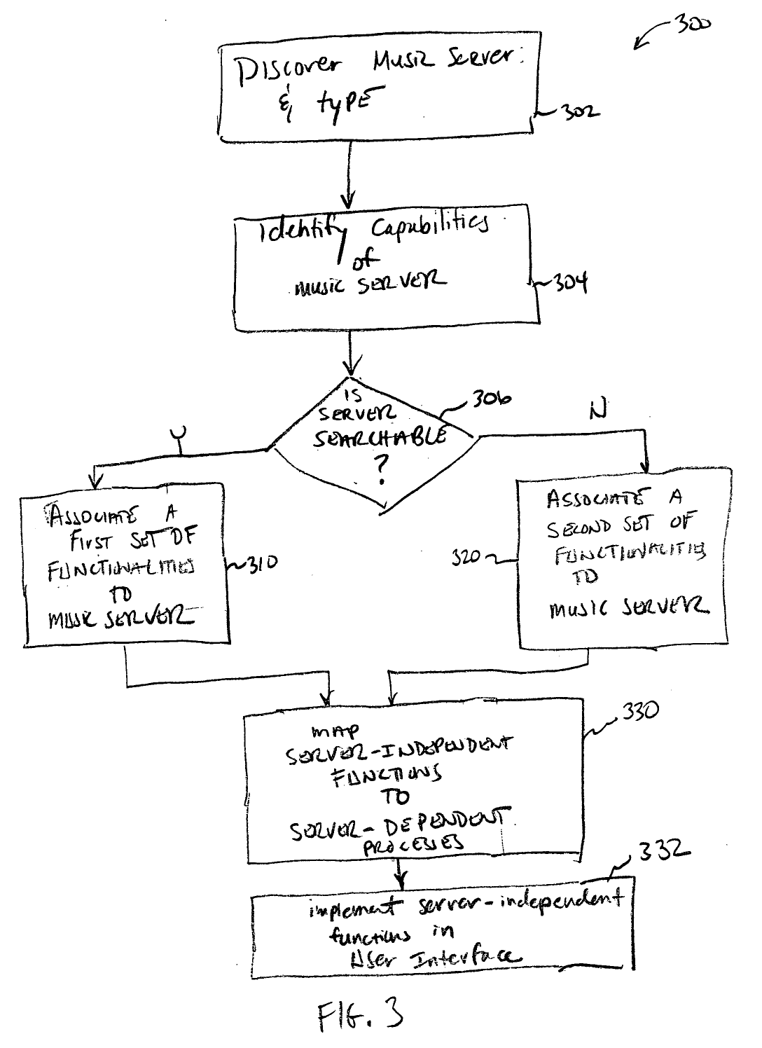

FIG. 2 is a system 200 including a universal music player, according to at least one embodiment of the present invention. In particular, FIG. 2 depicts a universal music player 250 coupled via a network 202 to a number of music servers. Universal music player 250 is configured to exchange data with music server (“1”) 212, music server (“2”) 222 and music server (“M”) 232, each respectively implementing server process (“A”) 214, server process (“B”) 224 and server process (“N”) 234. These server processes are each different, and as such, are incompatible with each other. In particular, each server process can represent either a unique discovery protocol or a unique communication protocol, or both, as well as any other protocol useable in serving music to a client music player. In a specific embodiment, network 202 is a local network, such as a digital home network (e.g., wired or wireless), and music servers 212, 222 and 232 are each composed of a computing device configured to execute instructions representing the server processes. Note that each of music servers 212, 222 and 232 can include or can couple to a memory (not shown) for storing music data and music-related data in a data structure. In at least one embodiment, different data access protocols are used for different music servers for interacting with (e.g., querying) those data structures. In a specific embodiment, universal music apparatus 250 includes a program engine 251 configured to communicate via one or more communication protocols with any of multiple music servers 212, 222 and 232, and access any of music servers 212, 222 and 232 to retrieve media data, which can include music data from music files and/or visual data representing a digitized image. 100251 Advantageously, universal music player 250 is configured to automatically detect and identify music servers and the server processes implemented therein. In various embodiments, each of the server processes in music servers 212, 222 and 232 is detectable by universal music player 250. That is, universal music player 250 is configured to detect the different types of server processes 214, 224 and 234 of which it is aware (i.e., predetermined prior to discovery). Further, universal music player 250 is configured to access music and related information irrespective of the underlying communications and/or data access protocols. As such, universal music player 250 interfaces with music servers that provide both browse and search (or query) capabilities, as well as basic music servers that only provide browsing capabilities. As used herein, the terms “browse” and “browsable” are used in some embodiments to describe a method of exporting data from a music server in which data resides. Browsing accesses data by recursively exploring a hierarchy of directories or folders. Generally, a user is presented a list of indicators (e.g., artist, genre, etc.) associated with parent folders that, when selected, will present items of the selected folder to a user. As an example, consider that a user wishes to browse all the “artists” of a music library. Upon initiating “browse ARTISTS,” the user interface can present an alphabetical listing of the artists. Then, the user scrolls up and down the list until a desired artist is found. The terms “search” and “searchable” are used in some embodiments to describe a method of exporting data from a music server in which data can be retrieved using a query language or instructions (i.e., without traversing a hierarchy of folders). Searching or querying a music server uses tags that specify, for example, a title, an artist, an album, a year, a genre, a composer, and the like. For instance, consider that a user wishes to search for a specific “artist” by the name of ARTIST_ONE. Upon initiating “search ARTISTS,” the user interface will present a text field so that the user can enter a string of one or more alpha-numeric characters to match against a data structure of a searchable database. In particular, the user will enter some or all of the following characters: A, R, T, I, S, T, _, O, N. and E to form a query. After a match is found, the user will be presented with the artist name of ARTIST_ONE. Note that UPNP and DAAP music servers include communications and data access protocols for performing queries and can respond by exporting music and music-related data corresponding to query or search parameters specified by user input. Also note that data representing music in a “browse-only” server is not configured for retrieval using a query language, unlike a searchable music server. As used herein, the term “music data” in some embodiments refers to data used to produce music (note that a music file contains sufficient music data to render one or more songs), whereas the term “music-related data” refers to peripheral data that describes the music data (e.g., data representing artist information) or the functions of playback. Further note that universal music player 250 is configured to support a wide range of music formats, such as WMA, AAC, WAV, MP3, AIFF, and the like.

So according to the present invention, universal music player 250 can serve as the sole client computing device on a network of disparate server processes. Further, it can provide for a user interface to convey generalized user inputs and outputs that are independent of the specialized server processes without, for example, manual intervention (e.g., without modifying executable instructions to adapt to each specialized server process). By contrast, traditional techniques of serving music to client music players rely on the music players being designed to accommodate those server processes of a specific music server. Generally, music players cannot support more than one type of server process. Note that universal music player 250 optionally includes one or more additional modules, as is discussed below, to implement fast browsing capabilities when viewing large music libraries, and other functionalities. Note too that universal music player 250 is not limited to playing music. According to various embodiments of the invention, universal music player 250 can operate as a universal media player for presenting photos or videos based on visual data received from any one of music servers 212, 222 and 232 that can serve visual data. As used herein, the term “media data” includes visual data representing digitized images, as well as music data, music-related data and other related data. Examples of digitized images include photos (i.e., static images) and videos (i.e., dynamic images).

Universal music player 250 is a client computing device including a program engine 251 and a universal discovery module 260, either of which can be composed of hardware or software, or both. Program engine 251 includes various layers representing abstractions of program instructions, including upper layer 252, object layer 254 and server process interface layer 256. Program engine 251 operates to control and to facilitate the various functions of universal music player 250 that are discussed herein, from accepting user inputs to generating user outputs. Program engine 251 operates also to control the discovery process of universal discovery module 260. Upper layer 252 includes higher-level data representations and/or executable program instructions for effectuating music database querying, such as providing a user interface (e.g., for accepting query data and for presenting music-related data) as well as application layer processing. Object layer 254 includes intermediate-level data representations and/or executable program instructions for maintaining representations of music servers as music server objects (“MSOs”) 253 and other music-related objects, according to an embodiment of the present invention. Objects, such as music server object 253, are used to translate or map relatively sophisticated discovery, communication and/or data access protocol instructions into music server objects (and vice versa) in terms that are independent to any specialized server process. Note that the term “object” is not intended to limit the various embodiments to implementations based on object-oriented programming languages. Rather, the term “object” can also refer to any data structure that can be used to abstract commands to access music servers 212, 222 and 232. As such, the functionalities defined by music server object 253, such as “search title =SONG TITLE,” can be expressed in a manner that is easily understood by those having little or no experience in programming the specialized server processes. In some embodiments, a portion of object layer 254 includes at least a repository for storing music server objects. Server process interface layer 256 includes lower-level data representations and/or executable program instructions for managing the exchange of data among universal music player 250 and music servers 212, 222, and 232.

Server process interface layer 256 includes, in whole or in part, server process interfaces, such as server process A interface (“SP A I/F”) 256a, server process B interface (“SP B I/F”) 256b, and server process C interface (“SP N I/F”) 256c. Each server process interface is composed of one or more sets of executable instructions that are specific to one of server processes 214, 224 and 234, with each set being mapped to a corresponding generalized server function. Notably, each server process interface is configured to exchange data in accordance with a unique communications protocol, such as those implemented with or as part of either UPnP or DAAP processes, for instance. As an example, consider that a generalized server function “search,” which is independent of any music server process, is implemented in the following snippet of pseudo-code: “search album title=ALBUM TITLE.” This code is configured to search collections of albums for those albums that contain the string “ALBUM TITLE” in the title). If that generalized server function were mapped to server process A interface 256a, then a first set of executable instructions would implement a UPnP process, so long as music server (“1”) 212 is a UPnP server. But if the generalized server function were mapped to server process B interface 256b, then a second set of executable instructions would implement a DAAP process, so long as music server (“2”) 222 is a DAAP server. Note that server process C interface (“SP N I/F”) 256c can represent executable instructions for implementing a process for any other type of music server.

Universal discovery module 260 is configured to automatically discover and identify networked devices capable of communicating data to universal music player 250, at least one of those devices being a music server. In a specific embodiment, universal discovery module 260 is composed of a suite of specialized discovery protocols (not shown) for detecting network music servers. Examples of discovery protocols include SSDP and Rendezvous. Universal discovery module 260 operates to detect the presence of a music server, and to determine the server's capabilities. Specifically, it identifies the music server's identifier (or name) and the type of server process contained therein (e.g., UPNP, DAAP, etc.). Each type of server process generally exchanges data with universal music player 250 in accordance with a unique communication protocol. It also can determine whether the user is required to login, whether a password is required, whether the music server is browsable and/or searchable, and other like server capabilities. Universal discovery module 260 is coupled to an object manager (“obj mgr”) 255, which is configured to form an instance of music server object 253 for each music server detected. In particular, universal discovery module 260 conveys the capabilities of a detected music server to object manager 255, which in turn, associates a number of applicable generalized functions to music server object 253 so that a user can interact (e.g., search a playlist) with the user interface (not shown). As is described next, universal music player 250 implements an exemplary method of FIG. 3 to discover music servers and to form music server objects 253 as instances of those music servers.

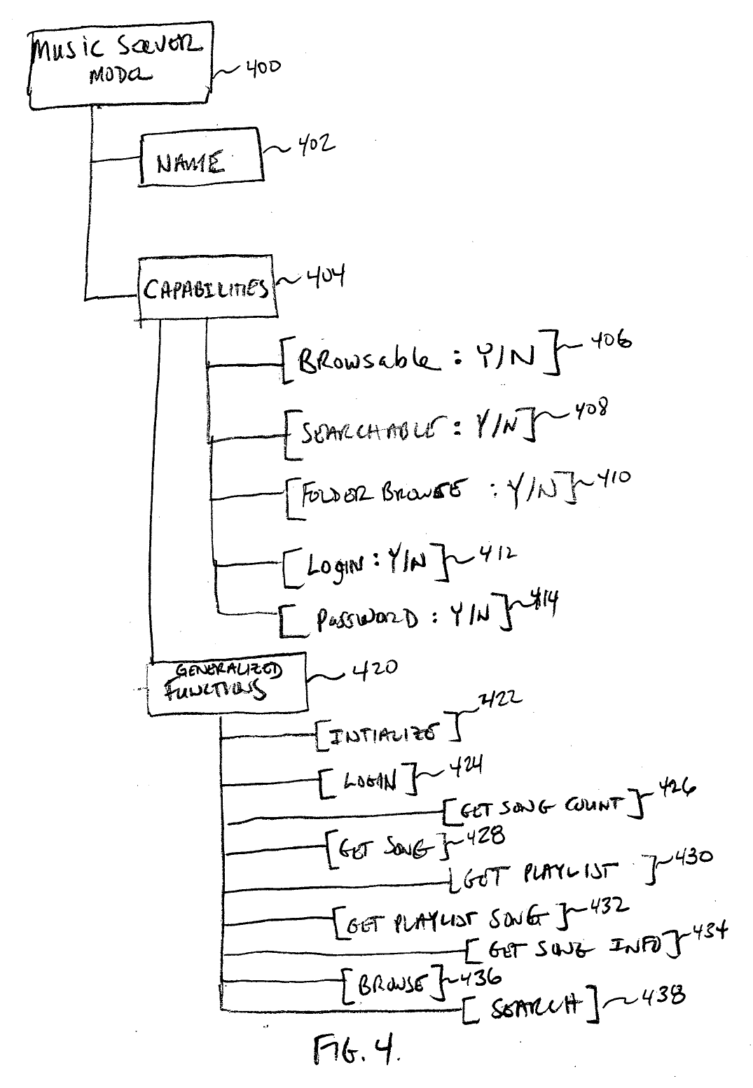

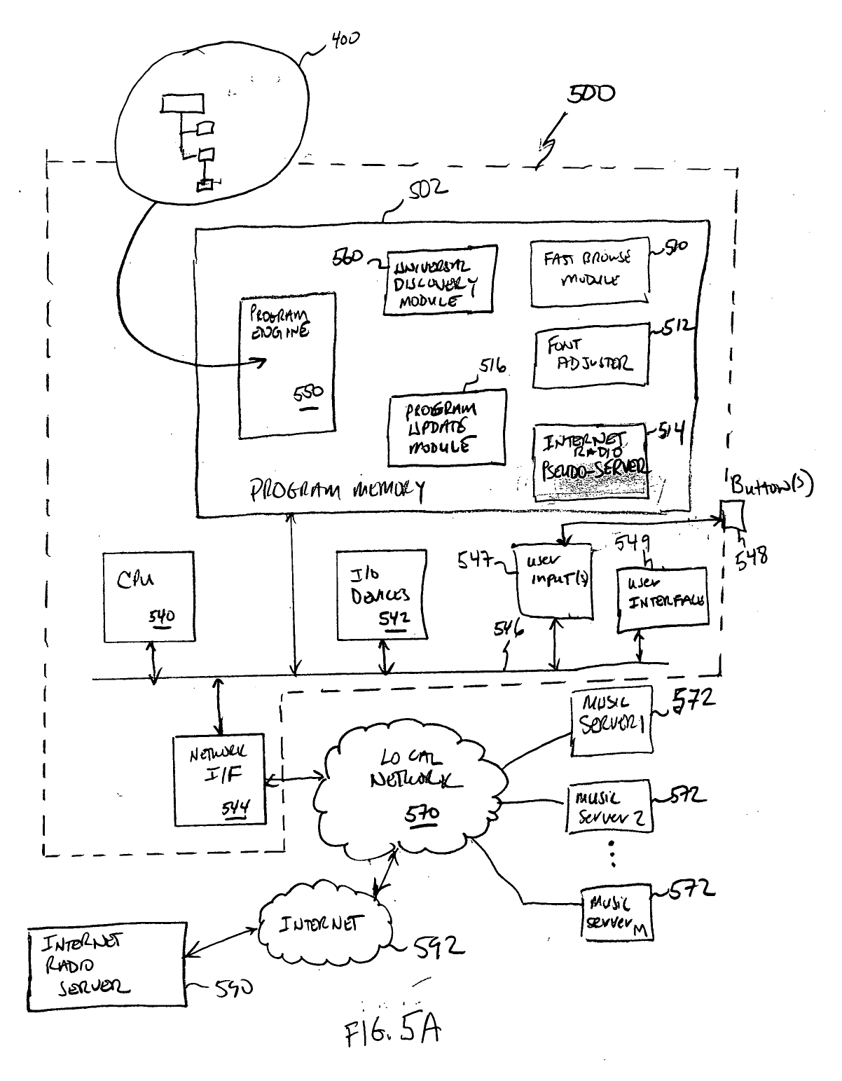

FIG. 3 is a flow diagram exemplifying a method with which universal music player 250 forms a music server object, according to an embodiment of the present invention. At 302, a universal discovery module uses one or more relevant discovery protocols to transmit or broadcast probes via a network to networked devices. Any music server configured to recognize the protocol of a particular probe will respond in kind. A responding music server typically returns its type of server, such as UPnP or DAAP, back to the universal discovery module. At 304, the universal discovery module determines the capabilities of a responding music server, with some of those capabilities being discussed herein, with respect to a music server model of FIG. 4. An object manager receives and then uses those capabilities to form a generalized representation of a music server discovered at 302.

At least one of those capabilities defines whether the music server is searchable (i.e., can be queried to any degree of granularity using a specific data access protocol) or whether it just has a capability to browse data structures containing music and other music-related data. If the object manager at 306 determines it is searchable, then at 310 it forms a music server object that has a first set of generalized functionalities that each map to, or are associated with, server-dependent sets of executable instructions. This mapping occurs at 330. But if at 306 the object manager determines that the server is not searchable (i.e., it only provides browsing capabilities), then it forms a music server object that has a second set of generalized functionalities at 320. In a specific embodiment, the first set of generalized functions maps to music servers capable of searching and querying the music files, whereas the second set maps to music servers capable of only browsing. At 332, a user via a user interface can implement the generalized functions of the music server to listen to music or to manage the playback thereof. In some embodiments, activity at 332 occurs subsequent to the “initialization” of the server, whereby initialization establishes an active connection with a music server.

FIG. 4 shows an example of a music server model from which a music server object is formed, according to one embodiment. Music server model 400 provides an application, such as user interface application, with a common view and a generalized way of interfacing to an element of server functionality implemented in accordance to a specialized server process. As shown, music server model 400 is associated with a name 402, which can be a property indicative of the music library implemented with a particular server process. For example, music server model 400 can associate “Dan's Music Library” to name 402. A universal music player will display this name on its user interface so that it can be selected. Upon determining the capabilities of a particular server, an object manager will define its capabilities 404 according to associated properties from 406 to 414. As shown, property 406 indicates whether the particular server is browsable (i.e., “Y” indicates yes) or not (i.e., “N,” indicates no), whereas property 408 indicates whether the particular server is searchable or not. Property 410 indicates whether the music server supports Folder Browse (sometimes referred to as “Browse-by-Folder”), which is typically implemented in UPnP servers that do not implement searching capabilities. As used herein, the term “Folder Browse” is used in some embodiments to describe a capability of a music server to represent a music library (i.e., a collection of music and music-related files) of a hierarchy for one or more folders, such as a folder named “90s Tunes.” With this hierarchy, a user can drill down into each folder to manually search for a music file. For example, a music server implementing Folder Browse can hierarchically arrange folders to represent “genre” as a parent folder, with one of the child folders being “rock music.” Then, an “artist” folder contained within “rock music” folder can contain folders for the artist's “albums,” each of which in turn contains songs and/or song data files. Property 412 and property 414 indicates whether the server requires a login and a password, respectively.

Once properties 406 to 414 are determined, those properties predetermine which functions of generalized functions 420 are useable with respect to a particular server. Each of generalized functions 420 is associated with, or are mapped to, a set of executable instructions that are server-dependent to realize, for example, server process interfaces 256a to 256c (FIG. 2). An initialize function 422 is associated with a set of instructions that initializes a music server to establish a connection between the music server and the universal music player. Login function 424 maps to instructions implementing a process for logging into a server process. Get Song Count function 426 is associated with a set of instructions that, for example, determines a number of songs in a collection of songs, whereby the collection of songs can be described by an argument, such as ALBUM. As such, Get Song Count (ALBUM) can retrieve a number of songs in an album. Get Song function 428 maps to instructions implementing a process for retrieving one or more songs, typically by querying a music server's relational data structure. Get Playlist function 430 maps user inputs to server-dependent instructions for retrieving the names of one or more play lists, which are listings of user-defined groups of songs. For example, the following snippet of pseudo-code “Get Playlist” causes one or more user-named play lists to be retrieved, such as a play list named “Disco Inferno.” By contrast, Get Playlist Song function 432 retrieves one or more songs of one or more play lists. For example, consider that the following snippet of pseudo-code “Get Playlist Song (Disco Inferno)” is designed to fetch all songs in the playlist named Disco Inferno. Get Song Info function 434 is associated with server-dependent instructions that, when executed, retrieve data representing music-related information, such as title, artist, composer, genre, length, track, album, and like information.

Notably, functions browse 436 and search 438 are associated with executable instructions for performing a browse and a search of a music server, respectively. Browse function 436 typically takes an argument, such as ALBUMS, ARTISTS, COMPOSERS, GENRES, and the like. For example, a universal music player executing the following pseudo-code snippet “Browse(COMPOSERS)” will return a listing of composers from which a user can browse for further selection. Similarly, Search function 438 typically takes an argument, such as ALBUMS, ARTISTS, TITLES, KEYWORDS, and the like, where each are entered as a string to match against a music server. Note that capabilities 404 and associated properties 406 to 414, as well as generalized functions 420 and associated functions 422 to 438 are merely representative of the generalized functions that a universal music player can perform. But in some cases, more or fewer functions can be implemented when modeling a music server in accordance with various embodiments of the present invention. For example, generalized functions 420 can include associations to sets of instructions for: building a song queue to stream digitized music from multiple music servers; reviewing a song queue; erasing a song queue; pausing music playback; and performing other like actions.

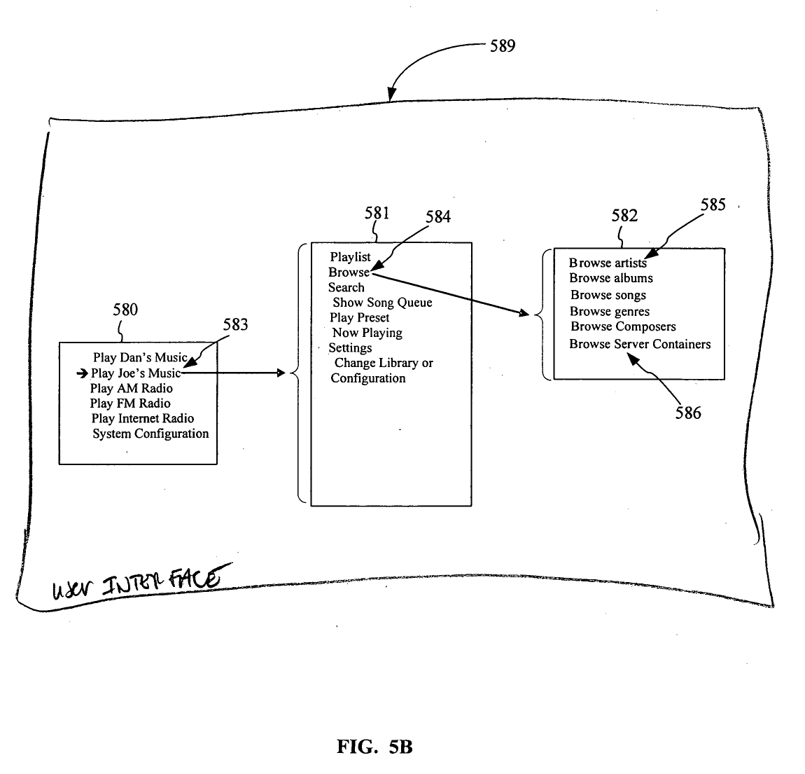

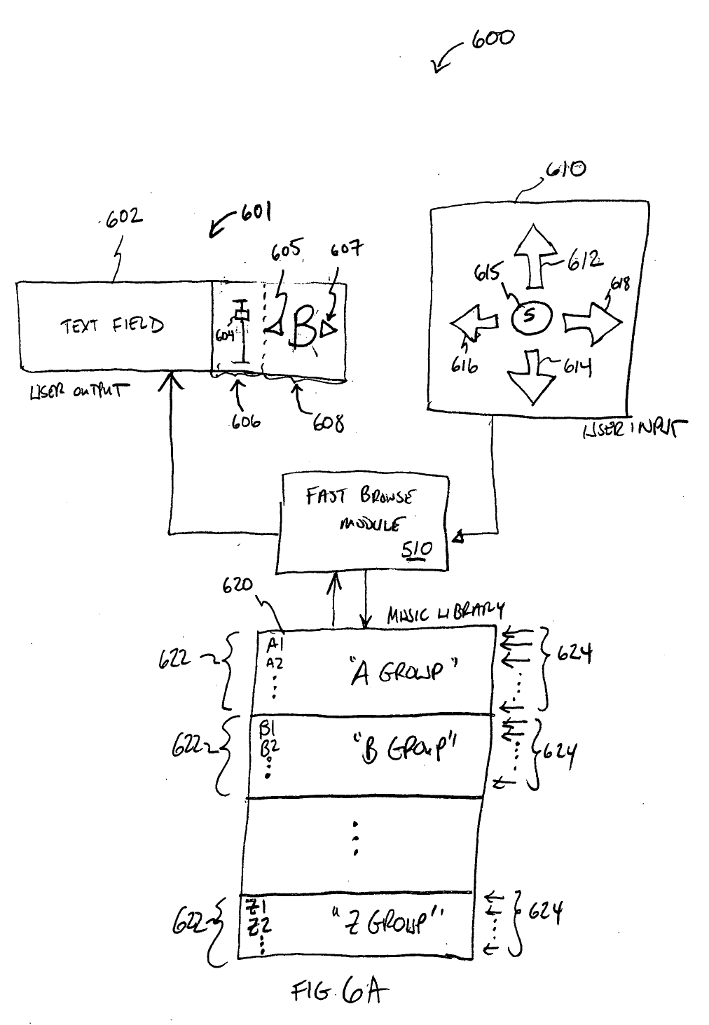

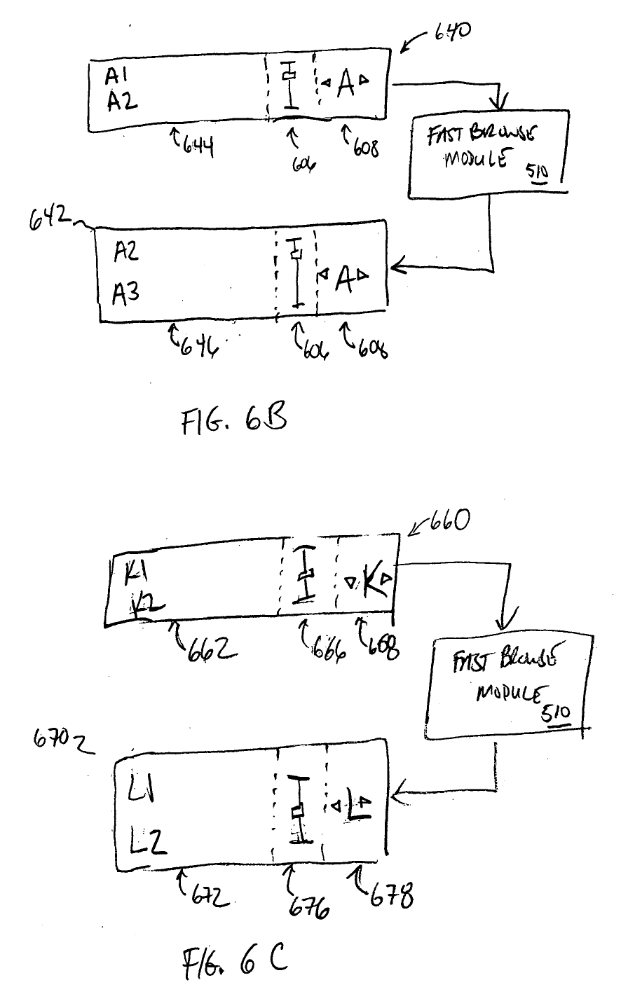

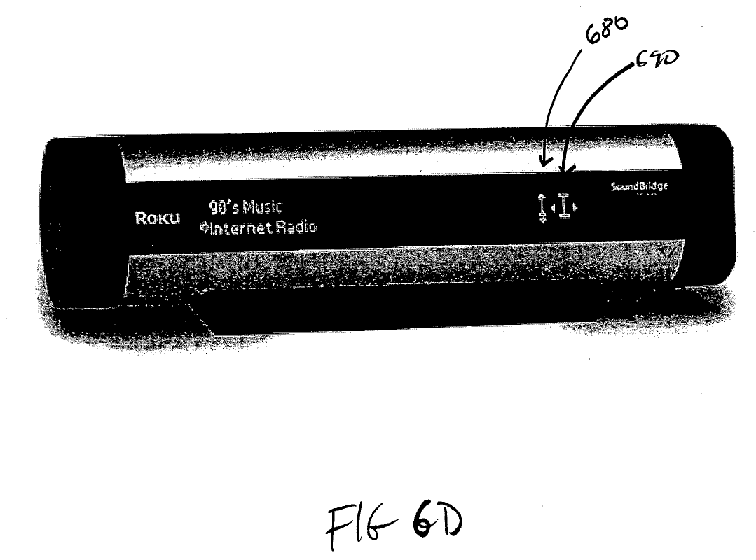

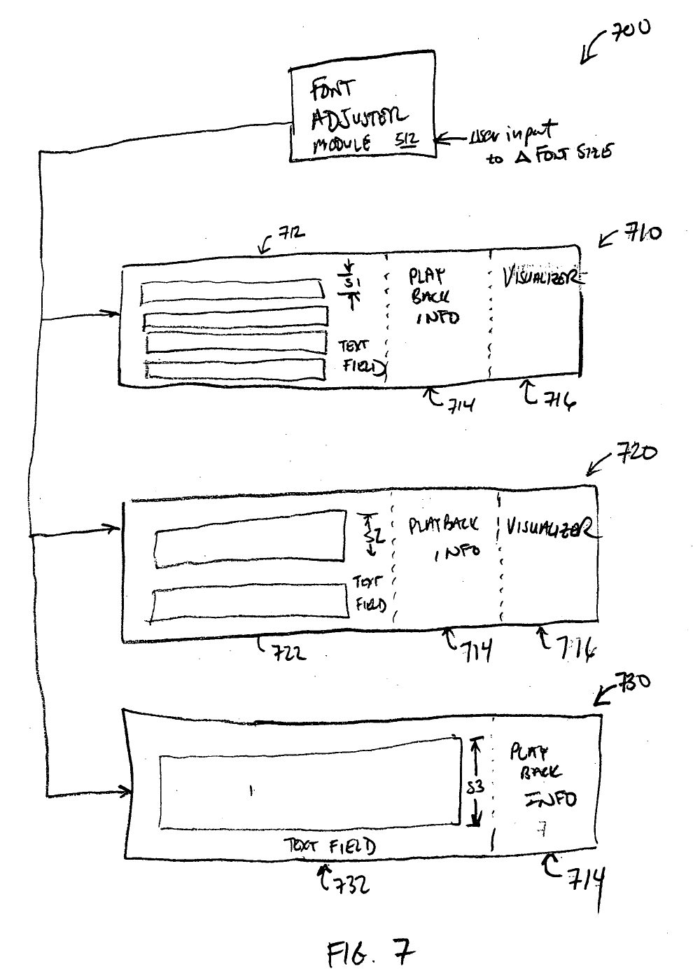

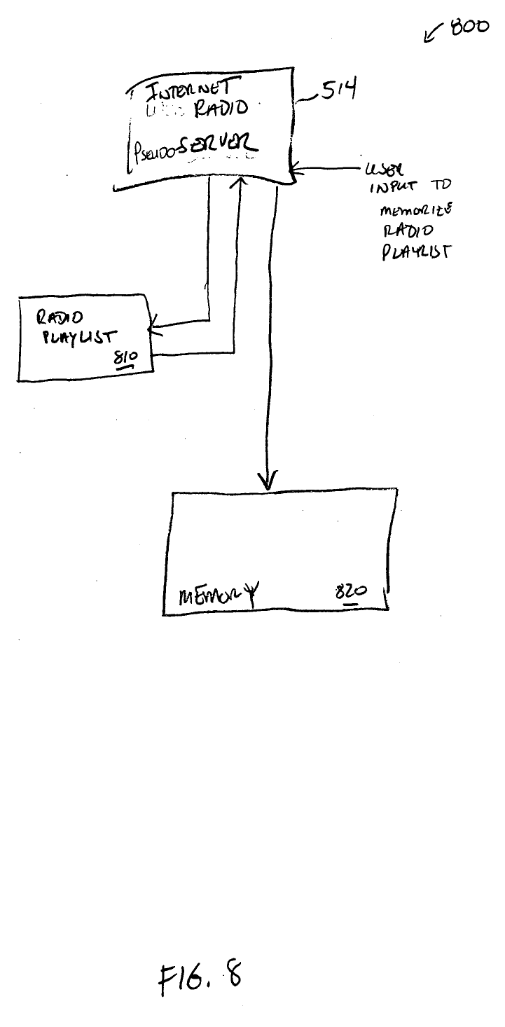

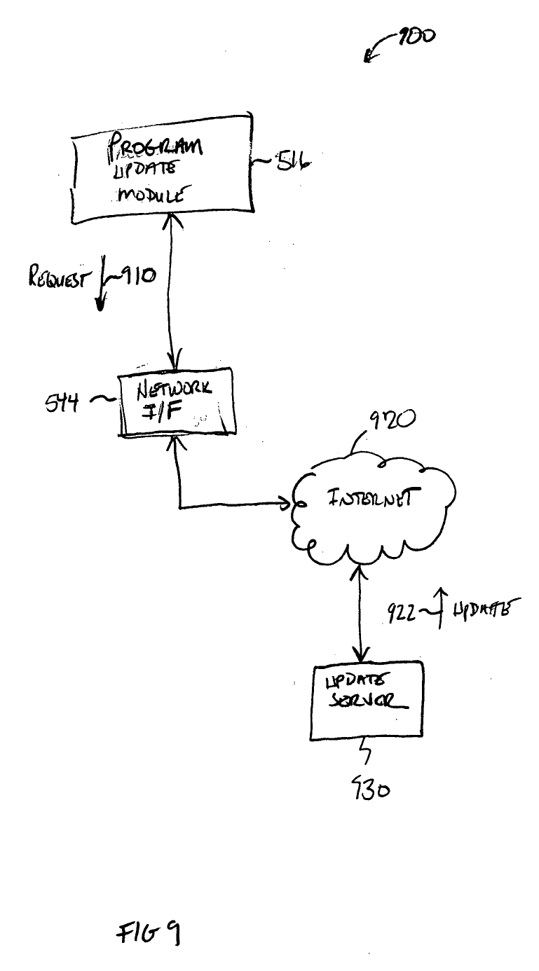

FIG. 5A introduces an architecture in which music server objects (“MSOs”) are implemented in a computing device to unify accesses to a number of specialized music servers, according to at least one embodiment of the present invention. In this example, universal music player 500 is a computing device composed of hardware modules, software modules, or a combination thereof. Universal music player 500 includes a program memory 502 that is connected to bus 546. Program memory 502 stores sets of executable programs to implement the functions for the various embodiments of the present invention. In one embodiment of the invention, subsets of executable program instructions stored in program memory 502 constitute program engine 550 and a universal discovery module 560. Program engine 550 and universal discovery module 560 have similar structures and/or functions as described above. As shown, FIG. 5A depicts an exemplary MSO 400 disposed in program engine 500, such as in an object layer (not shown). Optionally, program memory 502 can include additional subsets of executable program instructions to form one or more of the following: a fast browse module 510, a font adjuster module 512, an Internet radio pseudo-server 514, and a program update module 516, the functionalities of which are described in FIGS. 6, 7, 8 and 9, respectively. Universal music player 500 also includes a number of standard components, including a CPU 540, input/output (“I/O”) devices 542, such as a user interface (e.g., a graphical display for communicating music-related information and/or speakers for producing music) and/or a remote key pad, and a network interface (“I/F”) 544, all of which are configured to communicate via a bus 546. Network I/F 544 facilitates communications via any kind of local network 570 to another computing device, such as one that constitutes any of music servers 572. Network I/F 544 also facilitates communications with a networked “radio” server 590, such as an Internet-based server configured to serve (i.e., stream) data representing audio files including music. Networked radio (e.g., Internet radio) is based on the concept of streaming audio. A radio server 590 sends out a stream of audio signals, in whole or in part, in the form of music files (e.g., MP3 or other like digital audio format) over the network. Users who want to listen to a specific audio stream can instruct universal music server 500 to connect to the URL of the radio station they want to hear. Universal music server 500 then directs the stream of audio to a decoder or codec (neither is shown), for example, to play the incoming stream of audio signals.

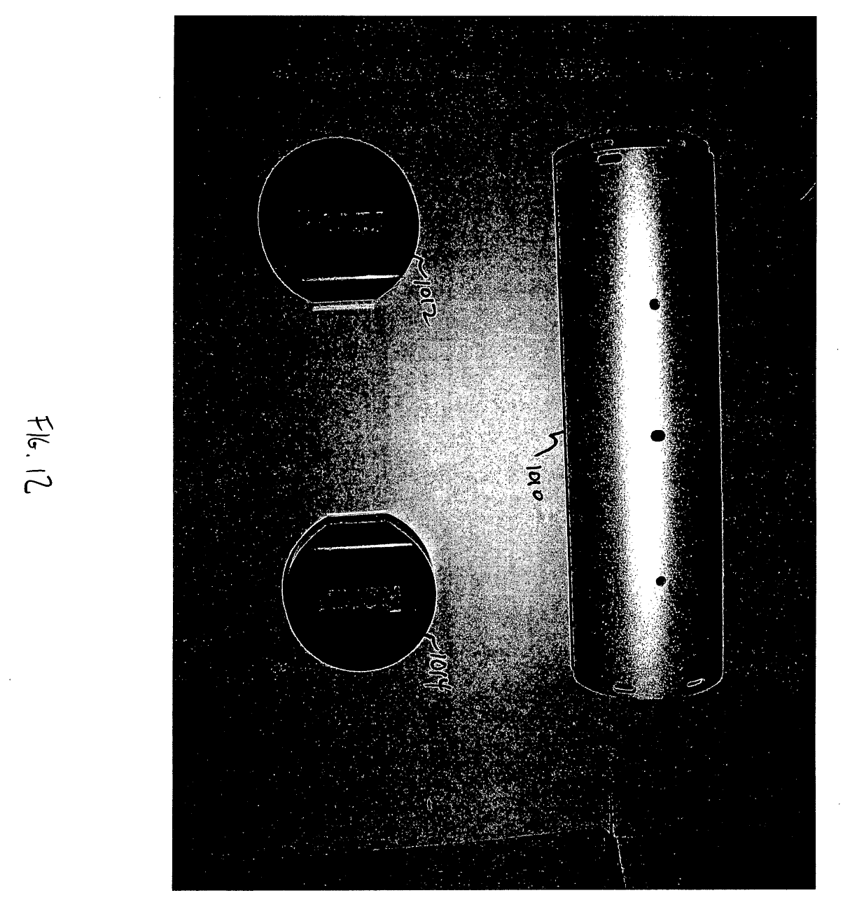

In one embodiment, program memory 502 includes one or more user inputs 547. For example, one or more user inputs 547 can include a number of buttons 548 extending out of a housing (not shown) for universal music player 500. When a button is activated (i.e., depressed), it can be configured to select to receive music data from, for example, either an Internet radio server 590 or a playlist (not shown). An example of such a playlist is shown as radio playlist 810 in FIG. 8. In another embodiment, program memory 502 can also include a display for presenting a user interface 549. In some cases, program engine 550 can be configured to generate generalized menus for presenting to a user the contents of a specialized music server regardless of the native functions and natively-generated menus that typically are associated with each of the different music servers. Advantageously, a user need only learn the generalized menus generated by universal music player 500 and need not learn the various natively-generated menus and functions, all of which can have different levels of complexity. FIG. 5B illustrates an example of generalized menus generated by universal music player 500, according to one embodiment.

One method of setting the radio station URLs for the Internet radio pseudo-server 514 is to “memorize a playlist.” To do this, a user creates a list of station names and/or URLs on their PC by using, for example, Apple iTunes(V to generate a playlist of Internet radio stations. Then, the user can use a function in the device to “memorize” this list. In this step, each of the user's “favorites radio stations” or “presets” is set to one of the list entries. In one embodiment, these entries can be stored in a flash ROM.

It should be appreciated that the executable modules illustrated in program memory 502 are exemplary. The functions of the invention may be implemented in any number of ways. In addition, it should be appreciated that functions of the invention need not be implemented on a single universal music player 500. The functions of the various embodiments of the present invention may be implemented across a set of servers, clients, clients and servers, etc. It is the functions of various embodiments that are significant, not where or how these functions are implemented.

FIG. 5B illustrates examples of generalized display formats presented by a user interface, according to an embodiment of the invention. In operation, program engine 550 generates a “source” menu 580 and then presents it to a user on user interface 549 of FIG. 5A. Advantageously, program engine 550 facilitates generating “source” menu 580 and other displayable information rather than relying on another entity, such as a music server, to generate such information. By contrast, conventional music players generally require the music servers to generate user interface information and then send that information via user interface messages to the conventional music players for display.

As shown, “source” menu 580 displays on user interface 589 the music servers that are discovered as individual options. These music servers could require the use of different communication protocols, or in other cases, they could be different servers that use the same protocol but with different configurations (for example, the name of the server, the PC the server is running on, etc). Once a user selects an option, for example “Joe's Music” 583, the “Home” 581 menu can be displayed on user interface 549 in a generalized display format. If the universal music player connects to a music server that supports “search” functionalities, then a consistent, generalized user interface is presented to the user. That is, generalized menu 581 and generalized menu 582 are generalized display formats in that they do not vary based on the servers' various “native browse functions.” For example, if the user selects “browse” 548, then generalized menu 582 can be displayed. Then if a user selects “browse artists” 585 in generalized menu 582, a server “search” function is performed, thereby querying the music server for all albums (or songs or other results) that match the selected artists. The list of albums can then be displayed, with the process continuing until the user finds the album or song that they wish to play. When displaying a result list (such as album or songs), the user can also be presented with an “all” option which allows them to select all albums (or songs or other list) instead of just one, for playback or other action.

Note that this approach of building user interface menus differs from a “server browse.” For example, when using a music server's “browse” function, the music server generates hierarchical, specialized menus, and the user is restricted to the lists the music server exposes. In generalized menu 582, an example is shown where the “Browses Server Containers” 586 option is presented to the user. Although every other “browse” option can use the server search functions to fetch results, the selection of “Browse Server Containers” option 586 allows the user to browse the server's actual hierarchy (i.e., the native hierarchy as generated by the music servers' native browse functions). When a music server does not support search (and query) functionalities, generalized menu 582 might not be shown. Instead, the root menu from a music server's “browse” menu can be displayed.

FIG. 6A illustrates a functional block diagram 600 depicting the functionality of fast browse module 510 of FIG. 5A, according to one embodiment of the present invention. Advantageously, fast browse module 510 enables a user to quickly browse through large lists, such as music libraries, artist lists, and playback lists. By contrast, conventional music players require a user to either scroll up and down one item at a time. In particular, conventional user interfaces implement an up and down arrow key for navigating through long lists of music files on an item-by-item basis. Often, a key-repeat feature is implemented to enable a user to hold down either the up or down arrow button to automatically scroll through the list on an item-by-item basis without repeatedly depressing a button. If the list is relatively long, it can be tedious and time consuming to select different song files located at various positions of the list. In one conventional approach, a traditional music player enables the user to only page up or page down to navigate on a group-by-group basis, each of the groups including only those song files displayed on the universal music player. This generally takes time to page through large categories of songs. For example, consider that a music library contains 40 songs starting with the letter “S.” Consider further that a universal music player displays 4 songs at a time. So if one wishes to “page up” or “page down” through all the songs starting with the letter “S,” then that person would be required to activate either the page up or page down operation 10 times. So while paging through contiguous groups of items is faster than navigating through each item individually, several page up or page down operations would still be required when paging through a portion of a list containing, for example, the letter “S.” Moreover, conventional approaches to paging up and paging down through music lists require two additional input keys for paging up and paging down from one group of items to a next group of items that immediately follow the previous group. For at least these reasons, conventional music players are relatively inefficient for browsing music libraries.

Various embodiments of the present invention implement a technique and user input pad that enables a user to skip through the list in large steps, for example, by skipping over groups of items having a common initial letter (e.g., the first letter of a title) if the list is sorted alphabetically, by a percentage if the list is not sorted alphabetically, or by any other user-defined manner of distinguishing subsets of items (i.e., music files). Advantageously, at least one embodiment configures the left button (e.g., input 616) and the right button (e.g., input 618) to perform the up and down navigation, respectively, though a list. By using the left and right button, two less buttons are required to be formed on a user interface, thereby preserving surface area of a remote control implementing keypad 610 that otherwise might be consumed by the above-mentioned two additional input keys for paging up and paging down from one group of items to the next.

In this example, fast browse module 510 (FIG. 5A) is configured to receive user inputs, such as from a keypad 610, which can be represent in whole or in part as I/O Devices 542. An example of keypad 610 is a directional pad, or “d-pad,” which typically consists of four directional controls (i.e., up, down, left and right), plus an optional select input button (“S”) 615. In response to user inputs, fast browse module 510 outputs data for graphically representing a portion of a music library 620 in a text field 602 of a display 601 for a universal music player. Display 601 also conveys a depth indicator 606 and a symbol field 608. Depth indicator 606 is configured to generally indicate a depth into, or a position within a music library. Symbol field 608 depicts a group identifier related to a set of grouped items, such as a set of songs. Typically, a group identifier is an alphanumeric character related to the first character of a song title. As shown, “B” in symbol field 608 conveys that fast browse module 510 is pointing to or is indicating a group of songs 622 starting with the letter B (i.e., the “B Group”) in music library 620. In some embodiments, symbol field 608 is configured to present a large letter (e.g. the letter “E”) flanked by a first representation 605 and a second representation of a left arrow 616 and a right arrow 618, respectively. In some cases, first representation 605 and second representation 607 are designed to visually match the respective shapes left arrow 616 and a right arrow 618 to enable a user to readily identify the functionality provided by inputs 616 and 618.

To browse at a coarse level of granularity, a user uses inputs 616 and 618 to move up and down, respectively, on a group 622 by group 622 basis. User inputs 612 and 614 are used to browse at a finer level of granularity to move up or down on an item 624 by item 624 basis, where the items in this example are songs. So as a user browses music library 620 at a coarse level, a depth bar 604 correspondingly indicates a relative depth (between the first and last items) for an item shown in text field 602. As shown, a user has coarsely browsed the group of songs beginning with the letter B, and as such, depth bar 604 indicates that the current selection in text field 602 is near the top of music library 620, the top coinciding in this case with the letter “A.” By conveying a depth and a symbol to a user in conjunction with a user input that enables coarse or fast browsing, a user is able to expeditiously locate and select a song from a relatively large list of songs.

FIGS. 6B and 6C illustrate examples of the functionality of fast browse module 510 of FIG. 5A, according to various embodiment of the present invention. FIG. 6B illustrates fast browse module 510 performing a fine browse operation. Initially, display 640 presents items “A1” and “A2” for a group of song items beginning with the letter “A,” as shown in symbol field 608. After a fine browse request via a user input, display 640 appears as display 642, with items “A2” and “A3” being presented for the same group. Note that depth indicator 606 negligibly moves in response to the fine browse operation. FIG. 6C illustrates fast browse module 510 performing a coarse browse operation. Initially, display 660 presents items “K1” and “K2” in text field 662 for a group of song items beginning with the letter “K,” as shown in symbol field 668. Note that depth indicator 666 is positioned near the middle of the list (e.g., as measured with respect to total number items, with respect to total number of groups, etc.). After a coarse browse request, display 660 appears as display 670, with items “L1” and “L2” being presented in text field 672 for a next group with song items beginning with the letter “L,” as shown in symbol field 678. Note that depth indicator 676 minimally moves to reflect the coarse browse operation. FIG. 6D illustrates an example of one position of depth indicator 680 with an exemplary ornamental design thereof. Note that symbol field 690 reflects a grouping of items beginning with a letter “I.”

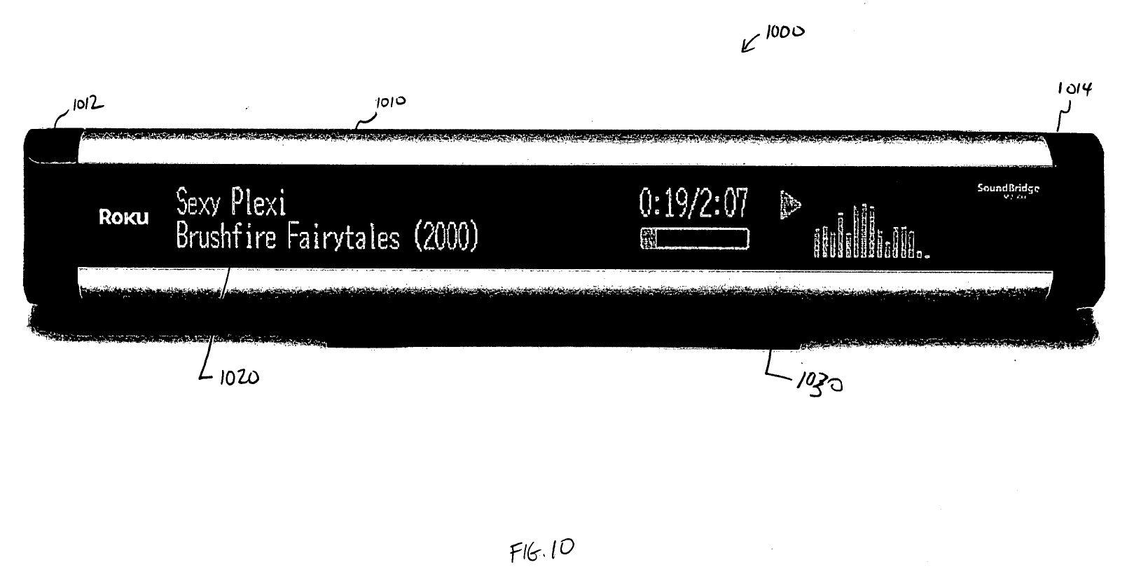

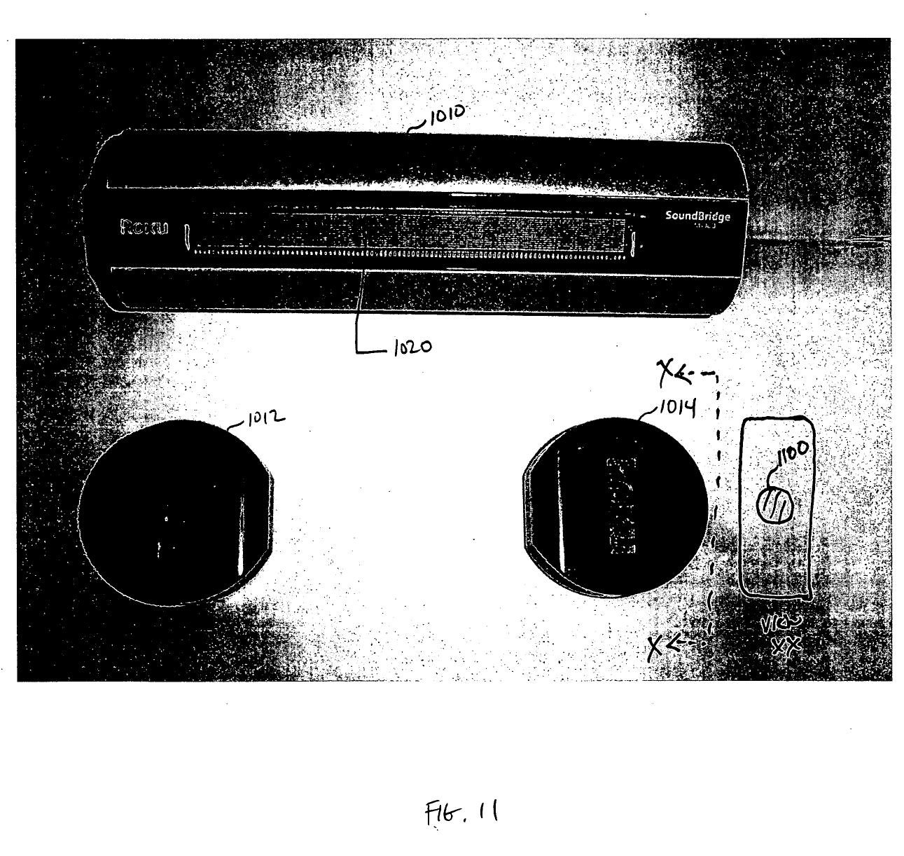

FIG. 7 illustrates a functional block diagram 700 depicting the functionality of font adjuster module 512 of FIG. 5A, according to one embodiment of the present invention. Advantageously, font adjuster module 512 enables a user to adjust the font size on, for example, a display 710, which can be composed of a Vacuum Fluorescent Display (“VFD”) or an equivalent. As such, font adjuster module 512 enables a user to accommodate the distance at which the user interface display, such as display 601 (FIG. 6A), is viewed. In a specific embodiment, which is not intended to be limiting, a user input is conveyed to font adjuster module 512 to change the font or text size. For a first input, font adjuster module 512 sets the font size to “s1” on display 710 such that four lines of text are visible in text field 712. For a second and a third input, font adjuster module 512 sets the font sizes “s2” and “s3” in text fields 722 and 732, respectively, for displays 720 and 730. Font size s3 is the largest, and as such, is optimal for viewing across large rooms. Note that font size s2 generally is associated with two lines of text and font size s3 generally is associated with one line of text. But display 730 can be configured to “slide” or laterally scroll text in text field 732 to sufficiently communicate strings of text to a user. Note that displays 710, 720 and 730 generally represent the same display on a universal music player with different font size settings. In a specific embodiment, other visual information presented on a display can be resized or eliminated by the font size adjustments made by font adjuster module 512. Examples of the other visual information include playback information (“playback info”) 714, which can include song information such as elapsed play time (or a graphical representation thereof), and visualizer information (“visualizer”) 716, which synthesizes graphics based on attributes of the sounds produced by playback of music. Note that display 730 omits visualizer information.

FIG. 8 illustrates a functional block diagram 800 depicting the functionality of Internet radio pseudo-server 514 of FIG. 5A, according to an embodiment of the present invention. Internet radio pseudo-server 514 is a pseudo-server configured to stream data representing at least audio from sources over the Internet. The term pseudo-server describes logic that serves audio files via both local network 570 and Internet 592 from a networked radio server 590. But to a user, networked radio server 590 appears as any one of music servers 572 (FIG. 5A) on local network 570. For example, Internet radio pseudo-server 514 can be associated with a server process interface, such as service process N (“SPN I/F”) 256n (FIG. 2) and can be accessed in a similar manner as other music servers 212, 222 and 232 (FIG.2). Also, the term radio in some embodiments refers to any service or logic reachable via a network, such as via Internet 592, that provides audio and/or video data on demand, generally in a continuous manner.

In this example, Internet radio pseudo-server 514 is configured to memorize a certain number (e.g., ten) web radio stations for later use. When Internet radio pseudo-server 514 receives a user input to memorize a radio playlist 810, which can be stored in a data structure in program memory 502 or elsewhere, Internet radio pseudo-server 514 queries radio playlist 810 to receive a number of Uniform Resource Locators (“URLs”), each of which identify a source of streaming audio and/or video, as well as other related information. Internet radio pseudo-server 514 then stores the URLs in memory 820, which can be composed of a local storage (e.g., a FLASH memory). In operation, program engine 550 passes control of fetching audio to Internet radio pseudo-server 514 when the universal music player is to play music from a networked radio source. Internet radio pseudo-server 514 then fetches an address, such as a URL, from memory 820 and uses that address to access audio via the Internet, for example. As such, sources of streaming audio and/or video data can be directly accessed via Internet 592 by a universal music player without passing through an intervening computer, such as a personal computer (“PC”), which is generally required by traditional music players to access music from radio play list 810 using conventional Internet radio services. Advantageously, Internet radio pseudo-server 514 implements radio playlist 810 without relying on an additional computing device (e.g., locally networked to network 570) that generally must be in an operative state for executing instructions, thereby consuming power even if only to provide radio playlist 810. In other embodiments, the user can manually create a radio play list, or the radio play list can be generated automatically or by default. For example, to manually create a radio play list, a user can use keypad 610 of FIG. 6 to enter a URL. To automatically create radio play list, universal music player 500 can be configured to save into radio play list 810 any URL that the user is currently accessing. Note that in some cases, an intervening computing device can be used to configure radio play list 810 by entering URLs in an HTML form or by dragging and dropping icons representing URLs, such as provided by iTunes. Regardless, an intervening computer is not required to access Internet radio stations at any time after the radio play list is formed.

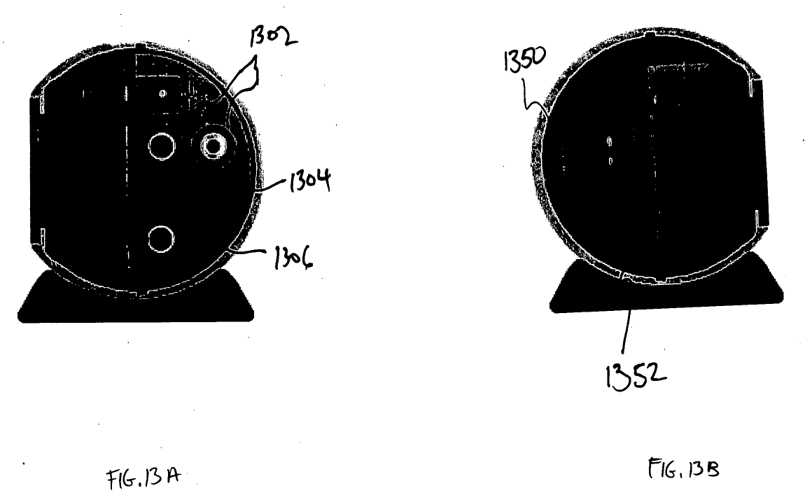

FIG. 9 illustrates a functional block diagram 900 depicting the functionality of program update module 516 of FIG. 5A, according to an embodiment of the present invention. Program update module 516 is configured to communicate from network interface (“Network I/F”) via Internet 920 to an update server 930 for obtaining revisions to any executable program instructions in a universal music player. Advantageously, a universal music player implementing program update module need not require intervention by a locally networked computer—as is generally required in conventional music player implementations—to download program updates from a server on the local network to the music player, which is typically the case for conventional music players. As such, support from another computing device is not required when providing program updates to the universal music player, thereby enabling the universal music player of various embodiments of the present invention to operate with the latest programs with minimal or negligible intervention by a user and/or a local server. In this example, program update module 516 is configured to generate a request 910 for a program update, regardless of whether it is initiated manually (e.g., during a “one-step” program update requests) or automatically. Update server 930 responds with an update 922, thereby providing for efficient program updates.

FIGS. 10-14 illustrate an exemplary housing for a universal music player in accordance with various embodiments of the present invention. FIG. 10 is a front view of universal music player 1000, which includes a display 1020, a body portion 1010 and end caps 1012 and 1014. Stand 1030 is designed to support body portion 1010 in a manner that permits display 1020 to rotate about an axis parallel to stand 1030, thereby allowing positioning to avoid glare from external lighting on display 1020 and to optimize the viewing position of universal music player 1000. FIG. 11 is a rear front view of universal music player 1000 with end caps 1012 and 1014 detached. Although the following applies to both end caps, view X-X depicts an orifice 1100 that faces rearward when end caps 1012 and 1014 are attached to body portion 1010. Advantageously, orifice 1100 guides cables (not shown) and other connection means rearward to exit the universal music player in a manner that is relatively hidden from the front view, thereby minimizing views of cables that are otherwise unaesthetic.

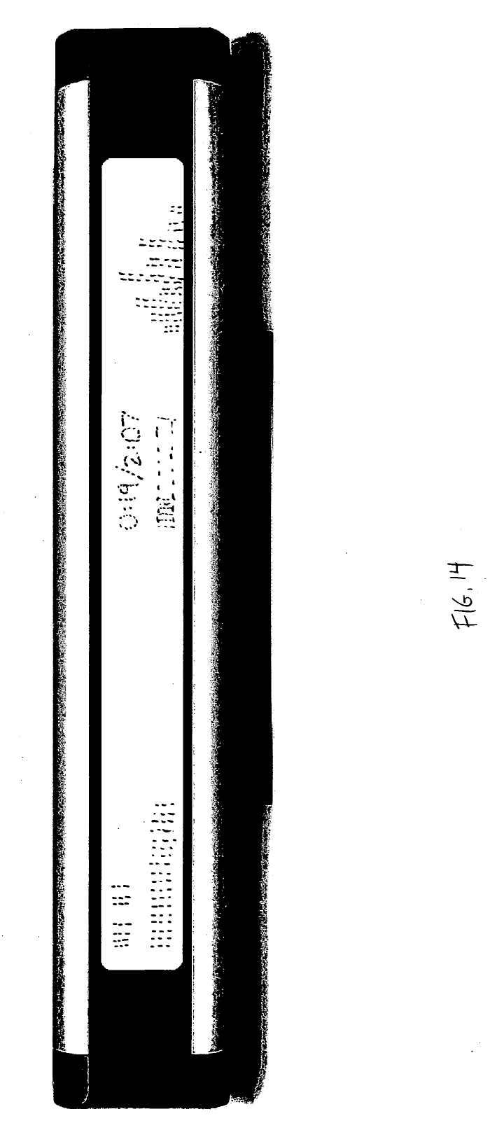

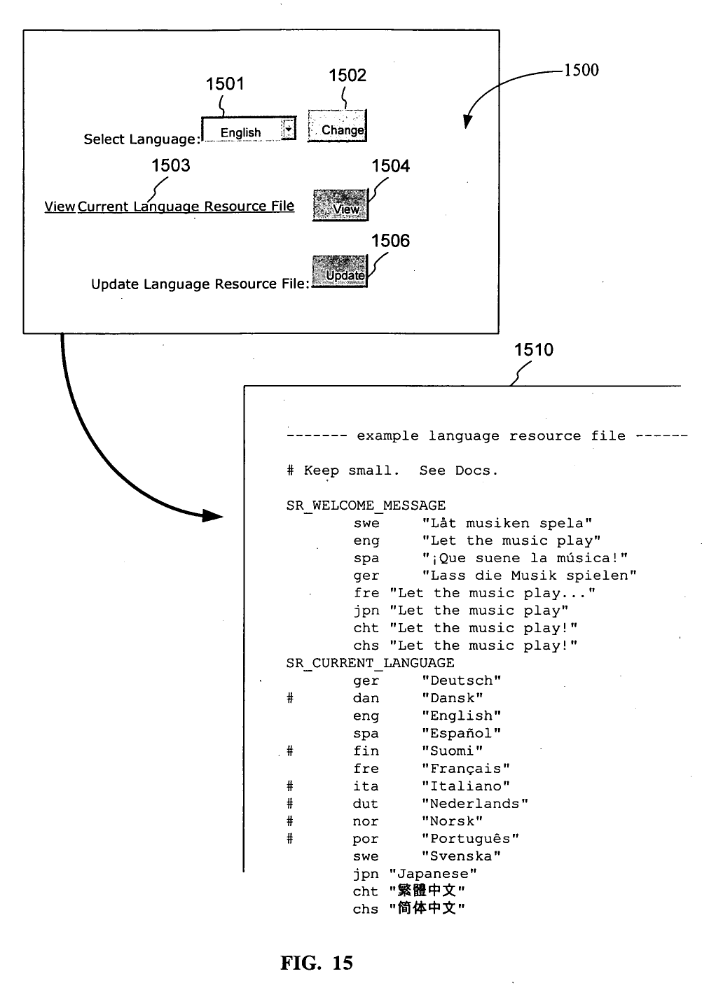

FIG. 12 illustrates a rear view of a universal music player. Note that when end caps 1012 and 1014 are attached to body portion 1010, orifices 1100 for both end caps would be visible in this view. FIGS. 13A and 13B show a number of connections requiring cabling for which orifices 1100 are desirable to hide. For example, connectors 1302 can be RCA jacks, connector 1304 can be an optical I/O, connector 1306 can be SPDIF coaxial connector, connector 1350 can be an Ethernet connector and 1352 can be a wireless connection card for implementing wireless networking. FIG. 14 is a front view of a universal music player including a display as part of a graphical user interface, according to one embodiment. In particular, FIG. 14 shows an ornamental design for a universal music player, whereby the broken lines illustrating graphical information on a display are for illustrative purposes only and form no part of the design.

15 shows a user interface for modifying the language in which information is displayed, according to an embodiment of the invention. For example, a universal music player can operate to modify the language in which it conveys information. That is, user interface 1500 of the universal music player (not shown) can be is fully customizable for languages using a resource file 1510. To select a language, a user selects one from pull-down menu 1501 and then implements the language selection with the “change” button 1502. To add a new language or modify an existing one, a user can download the current language resource file 1502 by selecting link 1503 (“View Current Language Resource File”) or by viewing it via “view” button 1504. Or, the user can modify it by updating resource file 1502 by uploading the modified resource file into the universal music apparatus using the “update” button 1504 to support the user's changes.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. In fact, this description should not be read to limit any feature or aspect of the present invention to any embodiment; rather features and aspects of one embodiment may readily be interchanged with other embodiments. For example, although the above description of the embodiments relate to a music player, the discussion is applicable to all media player that can present any type of content, including visual and audio information. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications; they thereby enable others skilled in the art to best utilize the invention and various embodiments with various modifications as are suited to the particular use contemplated. Notably, not every benefit described herein need be realized by each embodiment of the present invention; rather any specific embodiment can provide one or more of the advantages discussed above. It is intended that the following claims and their equivalents define the scope of the invention.

1. A universal music apparatus for unifying data accesses with multiple specialized music servers coupled to a network, said universal music apparatus comprising:
a program engine configured to:
communicate via one or more communication protocols with any of said multiple specialized music servers, and
access any of said multiple specialized music servers to acquire media data.

2. The universal music apparatus of claim 1 wherein said one or more communication protocols include different communications protocols.

3. The universal music apparatus of claim 2 wherein said program engine is configured further to generate generalized display formats for presenting generalized server functions for selection.

4. The universal music apparatus of claim 3 wherein program engine is further configured to build at least one of said generalized display formats as a generalized menu using a search function of any of said multiple specialized music servers.

5. The universal music apparatus of claim 1 further comprising:
a universal discovery module configured to:
discover at least one specialized music server from any number of specialized music servers, and to
identify said at least one specialized music server as a discovered music server.

6. The universal music apparatus of claim 5 wherein at least two of said number of specialized music servers are responsive to different discovery protocols.

7. The universal music apparatus of claim 5 wherein said program engine further comprises:
an object manager configured to determine one or more music server processes implemented in each of said discovered music servers; and
a number of interfaces each being configured to exchange data with an associated music server process of said music server processes using said one or more communication protocols,
wherein said object manager associates one or more generalized music server functions to said interfaces thereby enabling said generalized music server functions to communicate with any of said discovered music servers.

8. The universal music apparatus of claim 7 wherein said one or more music server processes comprise at least two music server processes that operate to serve media data in accordance with different communication protocols.

9. The universal music apparatus of claim 8 wherein said media data comprise either visual data or music data, or both.

10. The universal music apparatus of claim 8 wherein said one or more communication protocols comprise at least two different communication protocols.

11. The universal music apparatus of claim 7 further comprising:
a user input to accept a number of signals to initiate said generalized music server functions; and
a user output to present music-related information originating from any of said discovered music servers,
wherein said program engine is further configured to govern acceptance of said signals and presentation of said music-related information.

12. The universal music apparatus of claim 11 further comprising an object layer including a repository for storing music server objects, each music server object being formed to map generalized music server functions into server-dependent functions.

13. The universal music apparatus of claim 12 wherein said different communication protocols include data access protocols for accessing music files stored at said discovered music servers, whereby a first data access protocol facilitates only browsing music files, a second data access protocol facilitates only searching music files, and a third data access protocol facilitates both browsing and searching.

14. The universal music apparatus of claim 12 wherein each of said music server objects further comprises:
a name identifying a respective discovered music server;
a first property indicative of whether said respective discovered music server is capable of searching; and
a second property indicative of whether said respective discovered music server is capable of browsing.

15. The universal music apparatus of claim 14 wherein each of said music server objects further comprises:
a first association between a generalized browsing function and a first interface, if said first property indicates a capability to browse; and
a second association between a generalized search function and said first interface, if said first property indicates a capability to search,
wherein said first interface is responsive to a first user input to effectuate browsing of said respective discovered music server, said first interface including a first set of data access protocol instructions.

16. The universal music apparatus of claim 11 wherein said music-related information includes information about artists, titles, composers, genres, albums and play lists.

17. The universal music apparatus of claim 5 wherein said at least one of said discovered music servers operates in accordance with either a universal plug and play (“UPnP™”) process or a Digital Audio Access Protocol (“DAAP”) process.

18. The universal music apparatus of claim 11 wherein
said user input further comprises
two coarse browsing inputs and
two fine browsing inputs, and
said user output further comprises
a text field,
a listing depth indicator and
a symbol field.

19. The universal music apparatus of claim 18 wherein said universal music apparatus further comprises a fast browse module for coarsely browsing groups of items using said two coarse browsing inputs and for finely browsing items in said groups of items using said two fine browsing inputs, said groups of items each being identified by a group identifier, said items each being identified by an item name, said fast browse module configured to
present group identifiers in said symbol field, each of said group identifiers changing in response to said two coarse browsing inputs, to
present item names in said text field, each of said item names changing in response to said two fine browsing inputs, and to
indicate a relative position in a listing for all of said items.

20. The universal music apparatus of claim 11 wherein said user output further comprises a text field, said universal music apparatus further comprising:
a font adjuster module to change the size of text in said text field, thereby increasing viewing distance for said user output.

21. The universal music apparatus of claim 11 further comprising:
a program memory; and
an Internet radio pseudo-server configured accept a signal from said user input to memorize a radio play list that includes a listing of Uniform Resource Locators (“URLs”) and to store said listing of URLs in said program memory.

22. The universal music apparatus of claim 21 wherein said user inputs further comprise at least one button associated with said radio play list configured to select said radio play list for playing music when said at least one button is activated.

23. The universal music apparatus of claim 1 further comprising a program module update module configured to receive program updates from a remote server only through said network and the Internet, thereby excluding receiving said program updates from a computing device located on said network.

24. The universal music apparatus of claim 1 further comprising a housing including a tubular body, a display facing a first direction, and two end caps, each of said end caps including an orifice for receiving cables, said orifice positioned substantially in an opposite direction than that of said first direction, thereby minimizing visibility of said cables.

25. A computer readable medium including executable instructions to unify data accesses at a universal music player that is coupled via a network to multiple specialized music servers, said computer readable medium comprising executable instructions to:
discover one or more of at least two specialized music servers to form one or more discovered music servers, each being responsive to different discovery protocols;
identify different data access protocols for accessing data representing music, said different data access protocols being used by music server processes implemented at said one or more discovered music servers;
select one of said different data access protocols as a selected data access protocol; and
map a generalized music server function to executable instructions that are configured to implement a server-dependent function using said selected data access protocol,
wherein said generalized music server function is configured to map to a plurality of sets of executable instructions, each set being operable to access said data for retrieval from one of said one or more discovered music servers.

26. The computer readable medium of claim 25 wherein said executable instructions to map said generalized music server function further comprises executable instructions to model server-dependent functions implementing said different data access protocols as generalized server functions;
form a music server object to include a subset of said generalized server functions, said subset being determined by said selected data access protocol; and
store associations of said music server object that relate said subset of said generalized server function to corresponding sets of executable instructions to implement various server-dependent functions.

27. The computer readable medium of claim 26 further comprising executable instructions to:
accept a user input to perform said generalized music server function;
use said associations to specify said executable instructions for performing said server-dependent function; and
display a user output depicting music-related information originating from one of said one or more discovered music servers.

28. The computer readable medium of claim 25 further comprising executable instructions to:
coarsely browse groups of items in a music library;
finely browse items in said groups of items, said groups of items each being identified by a group identifier, and said items each being identified by an item name;
present group identifiers in a symbol field, each of said group identifiers changing in response to executing instructions to coarsely browse said music library, to
present item names in said text field, each of said item names changing in response to executing instructions to finely browse said music library; and
indicate a relative position with respect to other items in said music library.

29. The computer readable medium of claim 25 further comprising executable instructions to:
change the size of text in a text field, thereby increasing viewing distance for said user output;
accept a signal from a user input to memorize Uniform Resource Locators (“URLs”) used to stream music;
store said listing of URLs in a program memory;
initiating a request for receiving a program update; and
receiving said program update only from a connection extending from a remote server providing said program update through said network to said universal music player.
